(19) United States
(12) Patent Application Publication
(10) Pub. No.: US 2016/0373422 A1
(43) Pub. Date: Dec. 22, 2016

(54) USER IDENTITY BASED ON LOCATION PATTERNS OF NON-ASSOCIATED DEVICES

(71) Applicant: International Business Machines Corporation, Armonk, NY (US)

(72) Inventors: Austin F. Bruch, Clearwater, FL (US); Brad J. Fraley, Round Rock, TX (US); Patrick R. Wardrop, Austin, TX (US); Scott S. Wisson, Austin, TX (US)

(21) Appl. No.: 14/745,898

(22) Filed: Jun. 22, 2015

(51) Int. Cl. H04L 29/06; H04W 4/04

(52) U.S. Cl. CPC H04L 63/08; H04L 63/10; H04W 4/04

(57) ABSTRACT

Authentication of users is based at least in part on a comparison of environmental signals of a present location with environmental signals identified earlier for the present location. Verification of the user location supports authentication where a conventional user logon actions are insufficient.

### BACKGROUND

The present invention relates generally to the field of network security, and more particularly to authentication for remote access.

Protected object policies (POPs) are used to enforce certain access conditions on specific resources. An authentication strength policy makes it possible to control access to objects based on an authentication method. This functionality, sometimes referred to as step-up authentication, is used to ensure that a user who accesses more sensitive resources has to use a stronger authentication mechanism than initially used for the less sensitive resources. For example, greater security is provided to a junctioned region of a protected object space by applying a step-up POP policy that requires a stronger level of authentication than the client used when initially entering the domain.

When determining the identity of a user, state of the art solutions require an association of device(s) with known devices of the user (for example, a Wi-Fi access point, a paired Bluetooth device, a global system for mobile communications (GSM) mobile tower). The user information obtained from these associated devices is used to assign or verify a location for the user. Later attempts at authentication draw upon the user information obtained from a previous successful authentication, where a location was verified for the user. If the user is found to be at a different physical location when attempting an authentication, the user must provide step-up authentication. (Note: the term(s) “Wi-Fi,” “GSM” and/or “Bluetooth” may be subject to trademark rights in various jurisdictions throughout the world and are used here only in reference to the products or services properly denominated by the marks to the extent that such trademark rights may exist.)

Location verification is used frequently in social media environments where one member of a social group is able to find other members who are nearby.

### SUMMARY

In one aspect of the present invention, a method, a computer program product, and a system includes: storing a reference set of environmental signals for a specified location; receiving an authentication information from a user device at the specified location; responsive to receiving the authentication information, determining a current set of environmental signals for the specified location; and comparing the reference set of environmental signals with the current set of environmental signals to establish a risk score.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system; and

FIG. 3 is a schematic view of a machine logic (for example, software) portion of the first embodiment system.

### DETAILED DESCRIPTION

Authentication of users is based at least in part on a comparison of environmental signals of a present location with environmental signals identified earlier for the present location. Verification of the user location supports authentication where a conventional user logon actions are insufficient. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

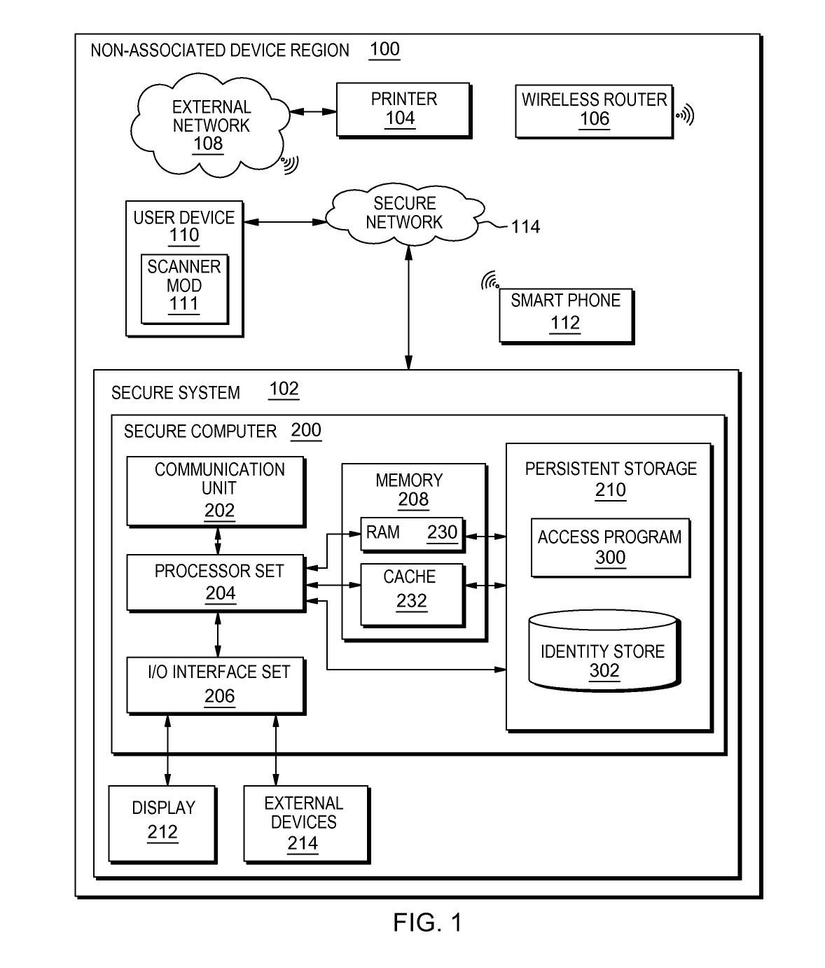

The present invention will now be described in detail with reference to the Figures. FIG. 1 is a functional block diagram illustrating various portions of non-associated device region 100, in accordance with one embodiment of the present invention, including: secure system 102; printer system 104; wireless router system 106; user device system 110; scanner module (“mod”) 111; smartphone system 112; external network 108; secure communication network 114; secure computer 200; communication unit 202; processor set 204; input/output (I/O) interface set 206; memory device 208; persistent storage device 210; display device 212; external device set 214; random access memory (RAM) devices 230; cache memory device 232; access program 300; and identity store 302.

System 102 is, in many respects, representative of the various computer sub-system(s) in the present invention. Accordingly, several portions of system 102 will now be discussed in the following paragraphs.

System 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

System 102 is capable of communicating with other computer systems, such as user device 110 via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

System 102 is shown as a block diagram with many double arrows. These double arrows (no separate reference numerals) represent a communications fabric, which provides communications between various components of system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for system 102; and/or (ii) devices external to system 102 may be able to provide memory for system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

External network 108 communicates with network printer 104 via a wireless interface that produces environment signals, discussion in more detail below. Wireless router 106 communicates with authenticated users over a wireless network and generates environmental signals. Smartphone 112 communicates with wireless telephone services and also generates environmental signals. The environmental signals are detectable by devices including user device 110 having scanner mod 111 that detects the environmental signals.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Access program 300 operates to determine a secondary identity of an authenticated user based on identified non-associated devices within a geographic region within which environmental signals from non-associated devices are received. The secondary identity is stored for later reference to confirm the identity of the user.

Context information provided by a non-associated device, such as a client mobile device (for example smartphone 112), is used to calculate a risk score for a transaction initiated by the client on an associated device, such as a laptop connected to a secure network. The laptop is able to locate various signals from non-associated devices such as external network 108 and wireless router 105 on which the user has not been authenticated.

Some embodiments of the present invention are directed to the determination of the identity of a user through the use of “non-associated devices” to determine a location of the user. “Non-associated” devices include any blue-tooth device that is running in promiscuous mode; WiFi routers; network printers; and/or nearby networks that the user is not logged into. The location information gained from non-associated devices for identifying a user may be stored and used to expedite later authorization attempts from the same location. When a latter attempt at an authorization determines that the recorded non-associated devices are not present at a particular location, the authenticating user may not have the identity that they claim. One responsive action to such a discrepancy is to initiate a step-up authentication or other multi-factor authentication to overcome the initial lack of authentication.

Some embodiments of the present invention are directed to a process that begins when a user attempts authentication by scanning for any non-associated devices to obtain corresponding GPS location(s) and other unique information such as a MAC address(es). Patterns are developed under the assumption that a user will authenticate in a location where the same non-associated devices are running. At some future time of authentication, a security application scans for the same non-associated devices that are associated with the location. If the set (or a defined majority of the same set) of non-associated devices is found, a certain level of confidence is assigned that the user is the same user that has authenticated before at that location. Similarly, if the set of non-associated devices is not found, authentication is suspect and a step-up authentication or other multi-factor authentication is required in order for the user to gain access to the desired system.

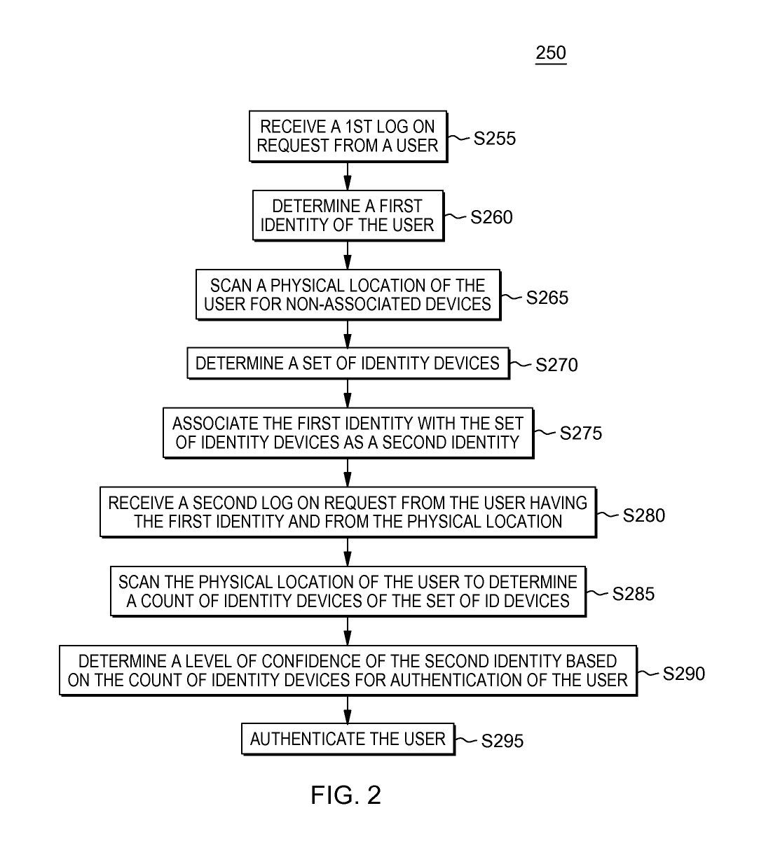

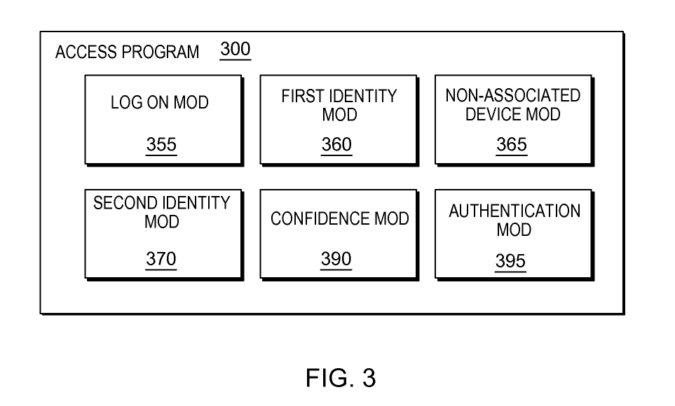

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where logon module (“mod”) 355 received a first logon request from a user. In this embodiment, the user has a pre-exiting account and logon established with secure network 114 (FIG. 1). However, the user is logging in with user device 110 (FIG. 1) from a new remote location, for example, the home of the user. Accordingly, the region in which the user's home is geographically located in represented by non-associated device region 100 (FIG. 1).

Processing proceeds to step S260, where first identify mod 360 determines a first identity of the user. In this embodiment, the first identity of the user is associated with the user's established account and is based on a successful login by the user with the user device, an associated device. That is, the user device is associated with the user so that when the user logs into secure network 114, the user device is recognized as being associated with the existing user account.

Processing proceeds to step S265, where non-associated device mod 365 scans a physical location of the user for non-associated devices. In this embodiment, the non-associated device module engages scanner mod 111 (FIG. 1) to scan the physical location for non-associated devices. That is to say, the scanner mod scans the non-associated device region for “environmental signals” produced by non-associated devices, such as printer 104, wireless router 106, and smartphone 112 (FIG. 1). Environmental signals are produced by devices within the physical location of the user device. The distance over which an environmental signal travels depends on various factors. It is sufficient to say that the non-associated device region is defined by the set of environmental signals that reach the scanner that is “listening” for the signals at the time that the location is being scanned. Sources of environmental signals include: (i) a bluetooth device running in promiscuous mode; (ii) network printers; (iii) smartphones; (iv) nearby external networks; (v) a WiFi router; (vi) 802.11 frames in a WiFi network; (vii) control messages in a 4G LTE network; (viii) frame bodies; (ix) cellular network traffic, such as temporary cell radio-network temporary identifier (TC-RNTI) and messages sent between LTE eNodeB and user terminals for identification and resource allocation; (x) a GPS-enabled device; and/or (xi) proximity-based technology such as near field communication (NFC).

Processing proceeds to step S270, where second identity mod 370 determines a set of identity devices. In this embodiment, the set of identity devices is shown in FIG. 1 as printer 104, wireless router 106, external network 108, and smartphone 112. These devices are identified in step S265 and stored as the set of identity devices by second identity module. Alternatively, a sub-set of all of the non-associated devices scanned in step S265 make up the set of identity devices. The determination of non-associated devices making up the sub-set is based on a pre-determined algorithm that may be established by organization policy, security administrators, or otherwise by those in authority to determine which non-associated devices are included in the set of identity devices. Determination of which environmental signals to include may be based on knows limitations of some signals, such as limited range, and/or low reproducibility quality.

Processing proceeds to step S275, where second identity mod 370 associates the first identity with the set of identity devices as a second identity. In this embodiment, the second identity information is stored in identity store 302 as triples, such that the first identity is matched with an identity device at a specified location. Alternatively, for a given location a set of identity devices is determined for use whenever a registered user logs in at the given location. In that way, the user's first identity is dis-associated with the geographic location.

Processing proceeds to step S280, where logon mod 355 receives a second logon request from the user having the first identity and from the same physical location. As will be discussed in the next few steps, when a user logs in from a physical location that has been scanned for non-associated devices, the authenticity of the user may be further based on the identification of the set of identity devices established in step S275. In this embodiment, the user logs into the secure network using a new device, prompting a question regarding authenticity. Alternatively, the user account is suspected of being used by an unauthorized person, so additional authentication is needed, such as verification of the location from which the user is logging in. Alternatively, the user attempts to access files that have a higher security requirement such that an additional confirmation of the user's location is needed.

Processing proceeds to step S285, where non-associated device mod 365 scans the physical location of the user to determine a count of identity devices of the set of identity devices established in step S275. In this embodiment, the non-associated device module engages scanner mod 111 (FIG. 1) to identify non-associated devices through environmental signals at the physical location of the user.

Processing proceeds to step S290, where confidence mod 390 determines a level of confidence of the second identity based on the count of identity devices for authentication of the user. In this embodiment, a simple count is used to determine whether or not each of the identity devices in the set of identity devices established in step S275 is present when the second logon request is received.

Table 1 shows a risk table for quantifying the risk of authenticating a user based on location. The “risk score” in the table considers a percentage of the devices identified in the present scan for non-associated devices compared with an earlier scan for non-associated devices in what should be the same location. According to the table, a risk rank of 1 is based on none of the non-associated devices appearing in the scan for devices. A risk rank of 5 is the lowest risk, where each of the devices in the set of identity devices is present in the current scan for devices.

TABLE 1
Ranking of Authenticated Location Risk.

| | EXTERNAL | | WIRELESS | |
|---|---|---|---|---|
| RISK | NETWORK, | PRINTER | ROUTER, | SMARTPHONE, |
| RANK | 108 | 104 | 106 | 112 |
| 1 | 0 | 0 | 0 | 0 |
| 2 | 1 | 0 | 0 | 0 |
| 3 | 1 | 1 | 0 | 0 |
| 4 | 1 | 1 | 1 | 0 |
| 5 | 1 | 1 | 1 | 1 |

Alternatively, a weighted rank is employed where some identity devices carry more weight than other in the authentication of the user's location.

Processing ends at step S295, where authentication mod 395 authenticates the user based on a sufficient level of confidence based on the identified identity devices. The particular level of confidence required for authentication is application specific and may be directed by an established global policy, or otherwise established by those in authority, such as the owners of the secure network, or corresponding data that is being accessed over the secure network. In this embodiment, the level of confidence is associated with the risk rank determined in step S290. For example, global policy may direct that a risk rank of 3 represents a sufficient level of confidence to authenticate the user based on an authenticated location.

Some embodiments of the present invention may include one, or more, of the following features, characteristics and/or advantages: (i) improves an identification process for verifying the location of a user; and/or (ii) determines identify using located non-associated devices, not requiring user interaction.

Some embodiment of the present invention are directed to a method for utilizing device context information to determine a user identity. Various steps of the method include: (i) receiving an initial context information from a first device by a second device, the initial context information comprising initial set of non-associated devices detected by the first device at a first location; (ii) receiving a request including a current context information from the first device by the second device, the current context comprising a current set of non-associated devices detected by the first device at a location; (iii) comparing the initial context information to the current context information to determine a risk score for the request; and (iv) responsive to the risk score exceeding a predetermined value, requiring additional authentication from the user to prove the user identity to proceed with the request.

Some embodiments of the present invention are directed to initial devices and/or current devices selected from a group consisting of a blue-tooth device running in promiscuous mode, a Wi-Fi router, a Network printer, a mobile network tower, and a GPS enabled device.

Some embodiments of the present invention are directed to a risk score that is based on a matching algorithm that requires at least some of the initial devices to match some of the current devices.

Some embodiments of the present invention cause the first device to scan for non-associated devices as part of a security protocol.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method comprising:
storing a reference set of environmental signals for a specified location;
receiving an authentication information from a user device at the specified location;
responsive to receiving the authentication information, determining a current set of environmental signals for the specified location; and
comparing the reference set of environmental signals with the current set of environmental signals to establish a risk score;
wherein:
at least the steps of determining and comparing are performed by computer software running on computer hardware.

2. The method of claim 1, further comprising:
determining user authentication based, at least in part, on the risk score.

3. The method of claim 1, further comprising:
receiving the reference set of environmental signals from the user device at the specified location.

4. The method of claim 1, wherein the set of environmental signals are generated by one of a blue-tooth device running in promiscuous mode, a wireless signal router, and a mobile network tower.

5. The method of claim 1, wherein each environmental signal of the set of environmental signals represents an electronic device other than the user device.

6. The method of claim 1, wherein the risk score corresponds to a percentage of environment signals in the set of reference environmental signals that are found in the set of current environmental signals.

7. A computer program product comprising a computer readable storage medium having stored thereon:
first program instructions programmed to store a reference set of environmental signals for a specified location;
second program instructions programmed to receive an authentication information from a user device at the specified location;
third program instructions programmed to, responsive to receiving the authentication information, determine a current set of environmental signals for the specified location; and
fourth program instructions programmed to compare the reference set of environmental signals with the current set of environmental signals to establish a risk score.

8. The computer program product of claim 7, further comprising:
fifth program instructions programmed to determine user authentication based, at least in part, on the risk score.

9. The computer program product of claim 7, further comprising:
fifth program instructions programmed to receiving the reference set of environmental signals from the user device at the specified location.

10. The computer program product of claim 7, wherein the set of environmental signals are generated by one of a blue-tooth device running in promiscuous mode, a wireless signal router, and a mobile network tower.

11. The computer program product of claim 7, wherein each environmental signal of the set of environmental signals represents an electronic device other than the user device.

12. The computer program product of claim 7, wherein the risk score corresponds to a percentage of environment signals in the set of reference environmental signals that are found in the set of current environmental signals.

13. A computer system comprising:
a processor(s) set; and
a computer readable storage medium;
wherein:
the processor set is structured, located, connected, and/or programmed to run program instructions stored on the computer readable storage medium; and
the program instructions include:
first program instructions programmed to store a reference set of environmental signals for a specified location;
second program instructions programmed to receive an authentication information from a user device at the specified location;
third program instructions programmed to, responsive to receiving the authentication information, determine a current set of environmental signals for the specified location; and
fourth program instructions programmed to compare the reference set of environmental signals with the current set of environmental signals to establish a risk score.

14. The computer system of claim 13, further comprising:
fifth program instructions programmed to determine user authentication based, at least in part, on the risk score.

15. The computer system of claim 13, further comprising:
fifth program instructions programmed to receiving the reference set of environmental signals from the user device at the specified location.

16. The computer system of claim 13, wherein the set of environmental signals are generated by one of a blue-tooth device running in promiscuous mode, a wireless signal router, and a mobile network tower.

17. The computer system of claim 13, wherein each environmental signal of the set of environmental signals represents an electronic device other than the user device.

18. The computer system of claim 13, wherein the risk score corresponds to a percentage of environment signals in the set of reference environmental signals that are found in the set of current environmental signals.
